(19) United States
(12) Patent Application Publication
(10) Pub. No.: US 2023/0105293 A1
(43) Pub. Date: Apr. 6, 2023

(54) GUIDANCE SECTION

(71) Applicant: Andrea Heuser, Daaden (DE)

(72) Inventor: Andrea Heuser, Daaden (DE)

(21) Appl. No.: 17/959,822

(22) Filed: Oct. 4, 2022

(30) Foreign Application Priority Data
Oct. 5, 2021 (DE) 10 2021 125 814.6

(51) Int. Cl. A01K 27/00

(52) U.S. Cl. CPC A01K 27/002; A01K 27/003; A01K 27/005

(57) ABSTRACT

A guidance section includes a strip-shaped guide web with a front and a rear end. The guide web has at least one fastening element at the front end and leg loops arranged at the rear end. At least two leash guides are provided, one of which is arranged on the guide web in the region of or near the rear end and the other of which is arranged at a distance from the guide web in the direction of the front end.

### CROSS REFERENCE TO RELATED APPLICATIONS

German Patent Reference DE 10 2021 125 814.6, filed 5 Oct. 2021, the priority document corresponding to this invention, to which a foreign priority benefit is claimed under Title 35, United States Code, Section 119, and its entire teachings are incorporated, by reference, into this specification.

### BACKGROUND OF THE INVENTION

### Field of the Invention

This invention relates to a guidance section including a strip-shaped guide web having a front end and a rear end.

### Discussion of Related Art

Typically, dogs are led on leashes in public to maintain control of the animal. Most often, leashes are attached to collars or harnesses. Harnesses are used for working dogs as well as in the leisure sector for walking, jogging, cycling or dog sports, as known for example from U.S. Patent Application Publication US 2010/0242861 A1, U.S. Patent Application Publication US 2021/0235669 A1 or German Patent Reference DE 20 2011 050 156 U1.

U.S. Patent Application Publication US 2008/0047501 A1 discloses a harness that contracts in the shoulder and chest area of the animal when traction is applied to a leash attached to the harness, This is to prevent the animal from escaping from the harness. However, such harnesses are disadvantageous in the way that they can cause panic reactions due to the contraction and, in the worst case, cause pain to the animal.

One disadvantage of using leashes to lead dogs on harnesses or collars is that the dog can get its legs caught in the leash. The leash can then wrap around one or more legs, for example, or run under the dog's belly between the legs. This impairs the function of the harness or collar and the leash. Freeing the dog from a tangled leash is time consuming and not very comfortable. In addition, an unintentionally tangled leash on the dog's belly, legs, or genital area can cause pain to the dog, for example, due to friction or when the leash is tightened in a jerky manner, or can also pose a risk of injury. Anxious dogs can quickly panic in such a situation, which makes it difficult to free the animal from the leash.

### SUMMARY OF THE INVENTION

It is one object of this invention to provide a guidance section by which it is possible to guide a dog on a leash and at the same time prevent the dog from becoming entangled in the leash.

In order to solve the problem, a guidance section is provided according to the features of this invention as described in this specification and the claims.

Advantageous embodiments and further embodiments of this invention are described in the dependent claims.

According to this invention, a guidance section is provided which comprises a strip-shaped guide web having a front end and a rear end. The guidance section rests on a dog's back and is suitable and intended to complement a wide variety of shapes and forms of harnesses or collars, for example common chest harnesses or also panic harnesses. The guide web preferably extends along an axis parallel to the longitudinal axis of the dog's back. However, other designs are also possible, such as a butterfly-shaped arrangement that adapts to the dog's anatomy. The guide web may be padded to increase comfort for the dog. The guide web includes at least one fastening element at the front end for releasable attachment to the harness or collar.

Such a fastening element is advantageous for securing the guidance section to the collar or harness in use in a non-slip manner and for releasing it after use. In this way, a guidance section can be used for a wide variety of harnesses or collars. In one embodiment, the guidance section has two fastening elements which, when used on the dog, are arranged on the front side of the guidance section facing the dog's head, so that the front end is aligned in the direction of the dog's head. This arrangement facilitates and reinforces the fixation and increases safety. Harnesses are usually designed as chest harnesses, so that the fastening elements are in close proximity to the harness due to this arrangement. This arrangement is also advantageous for the addition of a collar.

Leg loops are arranged at the rear end of the guide web. Preferably, at least two leg loops are provided for attachment to the dog's legs and preferably the leg loops are configured to be suitable for attachment to the dog's hind legs. Each leg loop extends in the form of a loop around a dog leg. The ends of the loop are connected to the guide web. This embodiment offers one advantage that the guidance section can be attached to the dog's body in a non-slip manner. In one embodiment, the leg loops are made of a flexible material, for example kernmantle rope. This offers the advantage that the material adapts to the dog's body and does not restrict the dog's movement.

At least two leash guides are provided along the guide web, one of which is arranged on the guide web in the area of or near the rear end and the other spaced in the direction of the front end. These serve to guide the leash securely. Preferably, the leash guide is arranged in the direction of the front end when resting on the back of the dog on the side facing the dog's head or in the middle of the guide web. Preferably it extends over a width of 2 to 6 cm, more preferably over a width of 3 to 5 cm. The length of this leash guide is variable, in one embodiment it extends over a length of at least 2 cm to ensure a safe and quiet leash guidance. At a distance from this leash guide, a further leash guide is arranged on the guide web in the area of or near the rear end, preferably just in front of the dog's tail base. Preferably, the width of this leash guide is oriented to the width of the leash guide in the direction of the front end of the guide web. The leash guides are configured such that a leash attached to the harness or collar can be guided through the leash guides along an axis parallel to the longitudinal axis of the dog's back. This arrangement and the resulting guidance of the leash offers the advantage that the leash remains on the dog's back even during rapid and involuntary movement of the dog and cannot become entangled between the dog's legs or loop around the dog's belly. The leash can be, for example, a drag line or a retractable leash, but other leashes for leading dogs are also possible. Even with jerky tightening of the leash or unforeseen changes of direction of the dog while walking, the leash remains on the dog's back, which prevents tangling. Especially in the case of fearful dogs, it is also important that the dog cannot free itself from its collar or harness. Even with so-called panic harnesses, which are supposed to prevent such a freeing, it cannot always be prevented that a fearful dog frees itself and escapes. The guidance section provides a safeguard so that the dog cannot escape from the leash guide.

According to one embodiment of this invention, the distance between the leash guides is between 5 and 40 cm, particularly preferably at least 10 cm. The distance between the leash guides is preferably selected depending on the size of the dog and in this way a safe leash guidance is guaranteed.

According to a further embodiment of this invention, the leash guide in the region of the rear end is formed essentially as an eyelet made of metal or plastic. A leash guide formed in this way in the region of or near the rear end is advantageous in order to improve the long-term stability of the guidance section, because it is subjected to greater stress by the movement of the leash in use.

According to another embodiment, the leash guide spaced in the direction of the front end is in the form of a fabric loop. Such a fabric loop is suitable, for example, for ac-accommodating a soft rubber label, for example for advantageous placement of a brand logo. However, it is also possible to provide the leash guide spaced in the direction of the front end essentially from an elastic soft rubber. These embodiments are advantageous for this leash guide in order to ensure a non-moving position of the leash passed through it, so that the leash does not negatively affect the dog.

According to another embodiment of this invention, the leg loops and/or the fastening elements are adjustable in length. For example, by using sliding buckles, the length of the leg loops and/or fastening elements can be individually adjusted so that an optimal fit is provided for harnesses or collars of different design and at the same time the anatomical conditions of the dog are taken into account.

According to another embodiment of this invention, the leg loops and/or the fastening elements each have a closure element for opening and re-closing. It is possible, for example, that the leg loops and/or fastening elements can each be opened and re-closed by a Velcro fastener, buckles, straps or plug-in fasteners in order to facilitate releasable fixation. A detachable fixation by knotting is also possible.

According to another embodiment of this invention, the leg loops have padding. The padding may, for example, be fixedly attached or detachably attached to the leg loops. Materials such as fleece or chloroprene rubber are suitable for padding, for example. Padding is advantageous, for example, to prevent chafing on the dog's body and to increase wearing comfort and thus acceptance by the dog.

According to another embodiment of this invention, an outer material of the guidance section has at least partially reflective properties. For example, the outer edges of the guidance section may be covered with reflective material. It is also possible that the entire guidance section has a reflective surface. Reflective material on the guidance section provides increased visibility of the dog in twilight and darkness, for example, because it is more clearly visible to motorists in their headlights and a collision can be avoided.

According to another embodiment of this invention, the guidance section is predominantly made of textile material. Preferably, it is characterized by high tensile strength in order to guarantee stability and longevity of the guidance section even in permanent use. On the one hand, this is economically advantageous, and on the other, the selection of a suitable material can ensure a high level of comfort for the dog. The absence of materials of animal origin is also advantageous from an animal welfare point of view. It is also possible to make the guidance section or parts thereof, for example the leg loops, from elastic material in order to increase the wearing comfort for the dog.

According to another embodiment of this invention, a harness or collar with a fastening eyelet for a leash is provided, to which the guidance section is fastened to the harness or collar with the fastening element adjacent to the fastening eyelet. In this way, the leash can be guided through the leash guides to the fastening eyelet and fastened there, so that safe guidance of the dog is ensured at all times by interaction of the harness or collar with the guidance section. The guidance section according to this invention is not intended and suitable for attaching a leash to a dog without the use of a collar or harness.

### BRIEF DESCRIPTION OF THE DRAWING

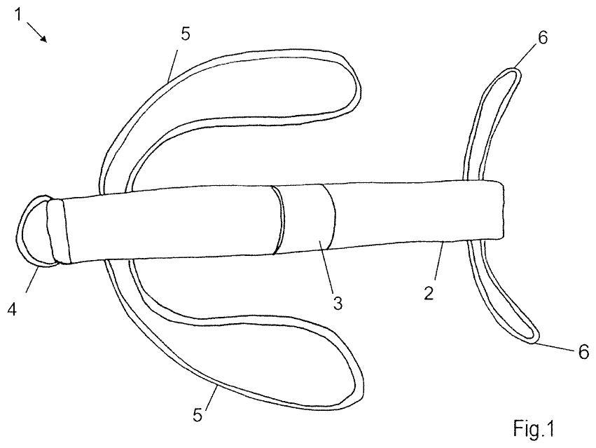

This invention is further explained below with reference to an embodiment shown in the drawing, wherein FIG. 1 is a top view of a guidance section according to this invention.

### DETAIL DESCRIPTION OF THE INVENTION

FIG. 1 shows a guidance section 1 that comprises a guide web 2 for resting on the back of the dog. Two fastening loops 6 are arranged on the guide web 2 on the front side facing the dog's head when it is placed on the dog's back. These serve to fix the guidance section 1 to a harness or collar. A leash guide 4 is arranged at or near the rear end of the guide web 2, which faces away from the dog's head when resting on the dog's back. There is also a leash guide 3 in the middle of the guide web 2. Both the leash guide 3,4 arranged at the rear end and the leash guide 3 arranged in the direction of the front end of the guide web 2 extend in their width over the entire width of the guide web 2. At the rear end of the guide web 2 facing away from the dog's head when resting on the dog's back, two leg loops 5 are also arranged. These serve to fasten the guidance section 1 to the dog's hind legs. Each leg loop 5 is placed around a respective hind leg. Preferably, the leg loops are adjustable in length so that they can be adapted to the dog's body. The length of the guide web 2 is preferably adapted to the length of the dog's back and is ideally selected so that the guide web 2 extends from the attachment eyelet for the leash of the collar or harness used to the base of the dog's tail, so that the leash guide 4 is arranged just in front of the base of the dog's tail. A leash attached to the harness or collar can be guided through the leash guides 3,4. The leash then rests on an axis parallel to a longitudinal axis of the dog's back, which prevents tangling of the leash between the dog's legs.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1. A guidance section comprising: a strip-shaped guide web with a front end and a rear end, the guide web having at least one fastening element at the front end and leg loops arranged at the rear end, at least two leash guides provided, one arranged on the guide web in the region of the rear end and the other arranged at a distance from the guide web in the direction of the front end.

2. The guidance section according to claim 1, wherein a distance between the leash guides is between 5 and 40 cm.

3. The guidance section according to claim 2, wherein the leash guide in the area of the rear end is essentially made of metal or plastic.

4. The guidance section according to claim 3, wherein the leash guide located in the direction of the front end is in the form of a fabric loop.

5. The guidance section according to claim 4, wherein the leg loops and/or fastening elements are adjustable in length.

6. The guidance section according to claim 5, wherein the leg loops and/or fastening elements each have a closing element for opening and re-closing.

7. The guidance section according to claim 6, wherein the leg loops have padding.

8. The guidance section according to claim 7, wherein an upper material of the guidance section has at least partially reflective properties.

9. The guidance section according to claim 8, wherein the guidance section is predominantly of a textile material.

10. A harness or collar with an attachment eyelet for a leash, wherein the guidance section according to claim 1 is attached to the harness or collar adjacent to the attachment eyelet by the fastening element.

11. The guidance section according to claim 1, wherein the leash guide in the area of the rear end is essentially made of metal or plastic.

12. The guidance section according to claim 1, wherein the leash guide located in the direction of the front end is in the form of a fabric loop.

13. The guidance section according to claim 1, wherein the leg loops and/or fastening elements are adjustable in length.

14. The guidance section according to claim 1, wherein the leg loops and/or fastening elements each have a closing element for opening and re-closing.

15. The guidance section according to claim 1, wherein the leg loops have padding.

16. The guidance section according to claim 1, wherein an upper material of the guidance section has at least partially reflective properties.

17. The guidance section according to claim 1, wherein the guidance section is predominantly of a textile material.
